(19) United States
(12) Patent Application Publication
(10) Pub. No.: US 2006/0089891 A1
(43) Pub. Date: Apr. 27, 2006

(54) System and method for generating expense information

(76) Inventor: Rakesh Kumar Nigam, New York, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/972,012

(22) Filed: Oct. 21, 2004

(51) Int. Cl. H04M 15/00; G06Q 40/00; G07F 19/00

(52) U.S. Cl. 705/34; 705/40

(57) ABSTRACT

A system and method for generating expense information are provided. According to the invention, an employee's bill having itemized charges is received and stored in a data storage system. The itemized charges are processed to determine whether they are business-related, in whole or in part, or not business-related using data sources identifying charges that are known to be at least partially business-related. Charges that cannot be determined as business-related or not business-related are marked as unknown. Employee input is received via a user interface that identifies the unknown charges as business-related or not business-related, and such employee input is stored in the data storage system to assist in identifying charges in the future. Once all charges have been determined to be business-related or not business-related, and have been approved by the employee and, optionally, a supervisor, an expense report may be generated.

### FIELD OF THE INVENTION

This invention relates to a system and method for generating expense information. In particular, this invention pertains to processing employee bills having itemized charges, such as employee phone bills, to determine which of the itemized charges are business-related, i.e., are expenses, and which are not business-related, i.e., are not expenses.

### BACKGROUND OF THE INVENTION

Ever since their advent, communication devices have been used by employees for both business and personal reasons. For instance, it is common for an employee to make a business phone call on his or her own personal phone. When the employee's monthly bill arrives listing every phone call made in the prior month, the employee has to review the bill, mark which of the phone calls were for business, add up the charges associated with the business calls, and then prepare an expense report with a copy of the phone bill. The employee then submits the expense report for reimbursement. Typically, a supervisor of the employee must approve the expense report in order for the employee to receive a reimbursement check from his or her company. This process is time consuming, subject to typographical errors, and consequently, expensive for the company involved. Accordingly, a need in the art exists for a way to simplify this process of preparing and submitting expense reports.

### SUMMARY OF THE INVENTION

These problems are addressed and a technical solution achieved in the art by a system and method for generating communication expense information. According to an embodiment of the invention, billing data having itemized charges for each employee in an organization are received from a data provider. The billing data may, for example, pertain to phone bills, where each itemized charge is associated with a communication destination address, such as a phone number. The billing data is stored in a data storage system and may be grouped by employee.

The billing data is processed to categorize the itemized charges as business-related, in whole or in part; non-business-related; or unknown charges. One or more data sources of known business-related and/or non-business-related charges may be referenced to assist in this categorization process. In the case of processing phone bills, one data source may be a company-wide contact list identifying known business-related and non-business-related phone numbers. Other data sources may be personal contact lists identifying known business-related and non-business-related phone numbers particular to each employee. These data sources may also include any other information about the employees that may be useful in categorizing charges.

A categorized list of charges for each employee is then sent to its associated employee. Upon receipt, the employee reviews the charges and their assigned categories for accuracy, and identifies the unknown charges as (a) business-related, in whole or in part, or (b) non-business-related via a user-interface. In one embodiment, only the unknown charges are sent to the employee for identification as business-related or non-business-related. Once all charges have been identified as either business-related or non-business-related and have been reviewed by the employee, the employee selects a “submit” button on the user-interface. It may be required that at least all business-related charges be approved by a supervisor. Any changes to the categories made by the employee and/or the supervisor may be stored in the data stores, which may be contact lists, to reduce the occurrence of unknown charges in the future.

With all itemized charges properly categorized and approved, expense information is generated from the approved itemized charges and output. The expense information may be output to a printer, other external devices, such as an accounting system, or one or more internal computer-readable memories. The expense information may take the form of an expense report and may be stored as a computer-readable file, such as a Portable Document Format (“PDF”) file, a word processing file, etc. The output expense information may be used to reimburse the employee for his or her expenses, and may be used for tax and reporting purposes. Accordingly, the present invention provides a simple, efficient, and rapid way to generate expense information required for such purposes.

### BRIEF DESCRIPTION OF THE DRAWINGS

A more complete understanding of this invention may be obtained from a consideration of this specification taken in conjunction with the drawings, in which:

FIG. 1 illustrates an expense information generation system according to an exemplary embodiment of the invention;

FIG. 2 illustrates a process flow according to the exemplary embodiment; and

FIGS. 3 and 4 illustrate employee input into the system according to the exemplary embodiment of the invention.

### DETAILED DESCRIPTION OF THE EXEMPLARY EMBODIMENT(S) OF THE INVENTION

The present invention efficiently produces expense information, such as communication expense information, while minimizing the need for human intervention and, consequently, increases the accuracy of such information. In particular, itemized charges are received in a computer-readable format from a billing data provider. An attempt is made to identify the itemized charges as expenses, in whole or in part. For at least the charges that cannot be identified as expenses, input is sought from the employee to whom the charges apply. The employee's responses are recorded to assist in identifying future charges as expenses, thereby decreasing the amount of input needed from the employee in the future. Once all expenses have been identified, approval of the expenses by a supervisor may be required, and expense information, which may include an expense report, may be generated. Accordingly, the laborious conventional tasks associated with generating an expense report are obviated.

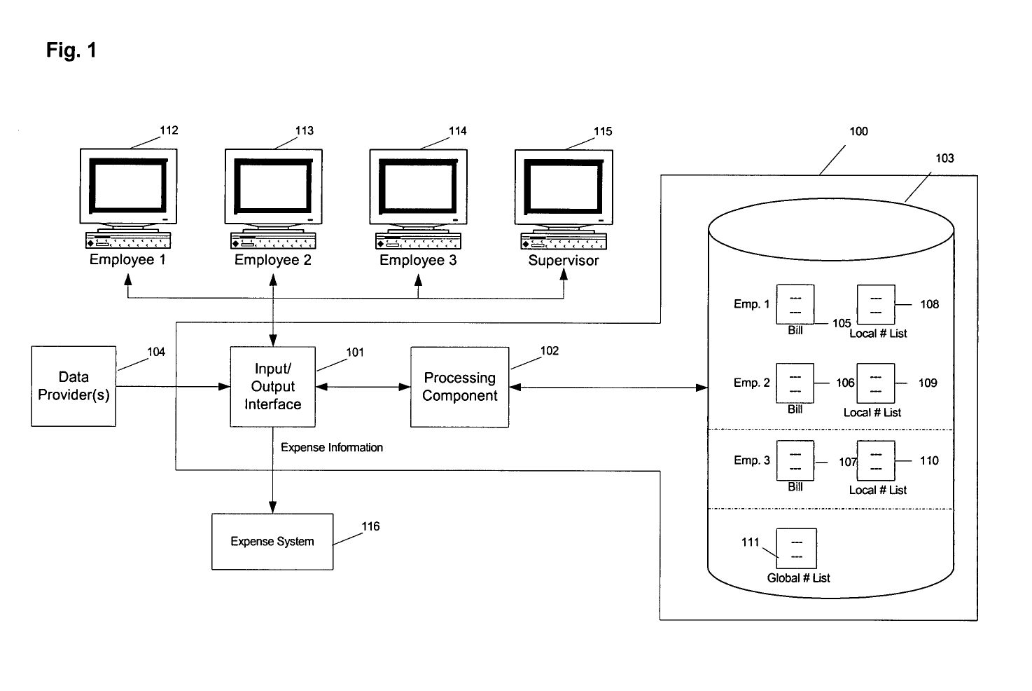

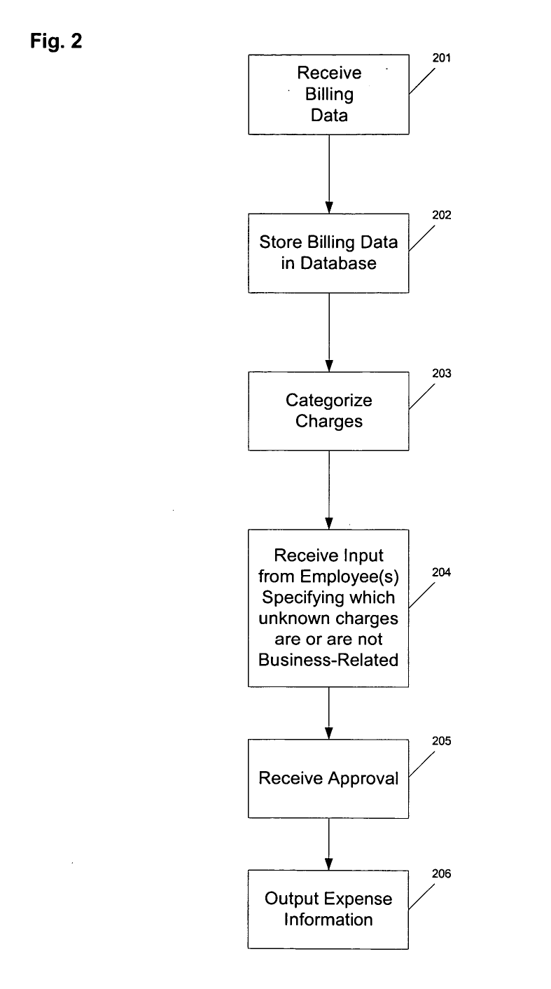

The present invention will be described in detail with reference to the figures. FIG. 1 illustrates an expense information generation system 100 according to one embodiment of the invention. The system 100 includes an input/output interface 101 communicatively connected to a processing component 102, and a data storage system 103 communicatively connected to the processing component 102. The input/output interface 101 transmits and receives data. The processing component 102 processes the data received by the interface 101 and executes the programs required to implement the processes described herein and illustrated with FIG. 2. The data storage system 103 stores the data received by the interface 101 and processed by the processing component 102. The data storage system 103 may exist in a single computer-readable memory within one computer, or may exist in multiple distributed computer-readable memories located on various computers or devices communicatively connected.

The term “computer” is intended to include any data processing device, such as a desktop computer, a laptop computer, a personal digital assistant, or any other device capable of processing data, whether implemented with electronics, optics, both, or otherwise. The term “computer-readable memory” is intended to include any computer-accessible data storage device, whether volatile or nonvolatile, electronic, optical, or otherwise.

The term “communicatively connected” is intended to include any type of connection, whether wired or wireless, in which data may be communicated. Further, the term “communicatively connected” is intended to include a connection within a single device or between devices. For example, the data storage system 103 may exist in a computer-readable memory located within the processing component 102 or may exist in a computer-readable memory located external to the processing component 102, or both.

Accordingly, although the system 100 is shown as including three separate components: an interface component 101, a processing component 102, and a data storage system 103, such components may be implemented within a single computer or multiple computers. For instance, a single computer may perform the functions of the interface component 101 and the processing component 102, and contain the data storage system 103 in its computer-readable memory. On the other hand, the system 100 may also be implemented using multiple computers communicatively connected. For instance, the interface component 101 may include one or more computers for receiving data from different channels, such as email, HTTP and HTTPS, application-program interfaces (“APIs”), or other channels. An example of an “interface computer” capable of receiving HTTP and HTTPS requests is a computer configured as a web server. An example of an interface computer capable of receiving email is a computer executing an email program, such as Microsoft Outlook. The processing component may be its own computer communicatively connected to the one or more interface computers acting as interface component 101 and one or more computers acting as the data storage system 103. An example of a computer acting as the processing component is an application server, known in the art. Accordingly, one skilled in the art will appreciate that the invention is not limited to the particular hardware arrangement used to implement the components 101, 102, and 103 of the system 100.

The system 100 is communicatively connected to one or more data providers 104 from which the system 100 receives billing data via the interface component 101. This receipt of billing data is illustrated at 201 in FIG. 2. The data provider(s) 104 may include one or more phone service suppliers, such as Vonage, Comcast, T-Mobile, AT&T, Verizon, Sprint, Vodafone, and/or Orange. According to an embodiment of the invention, the billing data includes itemized charges belonging to employees 112-114. The billing data may be, for example, an electronic version of employee phone bills for the previous month, where the itemized charges in the phone bills may include both business and personal charges. For instance, if a first employee 112 uses a phone plan from a first service provider, and a second employee 113 uses a phone plan from a second service provider, the system 100 may receive an electronic bill for the first employee 112 from the first service provider and an electronic bill for the second employee 113 from the second service provider.

Although often described in the context of phone bills, one skilled in the art will appreciate that the invention is not so limited. For example, the billing data from data providers 104 may include itemized charges associated with roaming charges, known in the art; text transfer charges, such as text messaging charges; voice communication charges, whether via telephone, cell phone, or voice-over-IP; data file transfer charges; and/or image transfer charges. So long as the billing data includes itemized charges, one skilled in the art will appreciate that such billing data is included within the scope of the invention.

The billing data may also include information that categorizes itemized charges as business-related, in whole or in part; or non-business-related. The billing data may also associate matter numbers with each of the itemized charges, which may be useful for determining which customers of the employee should ultimately be billed for the itemized charges or may be useful for assigning charges to particular departments of a company for budgeting purposes.

The billing data may be acquired from the data provider 104 using any number of methods. For instance, the data provider 104 may transmit the billing data as a single delimited text file, a spreadsheet file, or any other file including all bills for the previous month. Or, the data provider 104 may transmit the billing data as a plurality of delimited text files, spreadsheet files, or other files, each pertaining to less than all of the employee bills. The data provider 104 may also transmit the billing data as one or more images of each employee's physical bill that are then scanned in and converted to a word processing or text file using conventional techniques. The billing data may be manually or automatically transmitted to the system 100 every so often, such as every billing cycle, via, for example, email, CD-ROM, or an application-program interface (“API”). Alternatively, the system 100 may retrieve the billing data by accessing the data providers' 104 internal systems. For example, the system 100 may be configured to log into a secure web site and download the billing data directly from a data provider's 104 database.

The billing data transmitted by the data provider 104 is received by the interface component 101, which may translate the data into a desired format and forward it to a processing component 102. Depending upon design choice and the manner in which the billing data is transmitted to the system 100, the interface component 101 may be configured differently. For instance, if the billing data is transmitted from the data provider 104 via email, the input/output interface component 101 may include an API or an email application that receives the email, extracts the billing data, translates it, if necessary, and forwards it on to the processing component 102 for further processing. If the billing data is retrieved from a secure web site, the interface component 101 may include a user that manually logs into the secure web site using a web browser, downloads the data, and transmits it to the processing component 102. Alternatively, the interface component 101 may include a program that automatically logs into the secure web site, downloads the data, and transmits it to the processing component 102.

In view of the above-discussion and after reading this specification, one skilled in the art will appreciate that the invention is not limited to the format of the billing data provided to the system 100, the manner in which the billing data is provided to the system 100, or the configuration chosen for the interface component 101.

As shown at 202 in FIG. 2, once the billing data is received by the interface component 101 and forwarded to the processing component 102, the processing component 102 may store the billing data in the data storage system 103. The billing data may be grouped by employee in the storage system 103, as illustrated with reference numerals 105-107, so that a set of itemized charges are stored for each employee. In the situation where the billing data includes employee phone bills, the set of itemized charges for each employee may include phone numbers of calls made by the employee in the previous month and the charges associated with them.

In cases where an employee switches service plans, the employee may have two different sets of billing data from two different data providers 104. In this situation, the processing component 102 may combine the two (or more) sets of billing data and store the combined billing data in the data storage system 103 under the respective employee. Once such combined billing data is stored in the data storage system 103, it becomes transparent to downstream processing that the employee switched service providers.

Also stored in the storage system 103 may be a data source 111 useful for identifying which itemized charges for all employees are business-related, in whole or in part, or not business-related. In other words, the data source 111 used to identify whether charges are business or non-business-related applies to all employees, and may identify charges as completely business-related, completely non-business-related, or partially business-related. Data source 111 may also identify global matter numbers associated with itemized charges.

In the situation where the itemized charges are phone calls, the data source 111 may be a company-wide phone listing identifying the phone numbers of all employees, clients, vendors, etc. of the company deemed to be business-related. The data source 111 may identify business-related, in whole or in part, or non-business-related charges, as the case may be using partial phone numbers, such as “(555)-555-****”. In this example, the asterisks represent any number, and all calls made to phone numbers beginning with “555-555” are deemed business-related, in whole or in part, or non-business-related, as the case may be. Further, the data source 111 may identify special calling numbers, such as 911 or phone numbers beginning with an asterisk. Depending upon policy choice, such numbers may be deemed business-related, in whole or in part, or non-business-related.

The storage system 103 may also include an additional data source for each employee, as shown by data sources 108-110. Such data sources 108-110 may include data specific to each employee that is useful for identifying which of the itemized charges are business-related, in whole or in part, or not business-related. In the situation where the itemized charges are associated with phone calls, the data sources 108-110 may be a list of phone numbers specific to each employee that are deemed either business-related, in whole or in part, or not business-related. Such data sources 108-110 may include phone numbers of customers specific to a particular employee, which are deemed business-related, or may include phone numbers of each employee's family members and friends, which are deemed partially business-related or not business-related. To elaborate, a phone call from an employee to the employee's home phone number may be deemed partially business-related. For instance, when the employee is on a business trip, a phone call to home may be deemed 50% business-related and 50% non-business-related, so that half of the call is reimbursed to the employee and the other half is not. Data sources 108-111 may also identify matter numbers associated with itemized charges for a particular employee.

As represented at 203 in FIG. 2, the processing component 102 may categorize each of the itemized charges for each employee 105-107 as business-related, in whole or in part; not business-related; or unknown using at least the data sources 108-111, and any information provided by the billing data itself. After categorizing the itemized charges, each employee's itemized charges are made available for his or her review. Optionally, only the itemized charges categorized as unknown are made available to the employee for review. Also optionally, the itemized charges are not categorized and are just made available to the employee to review and manually categorize.

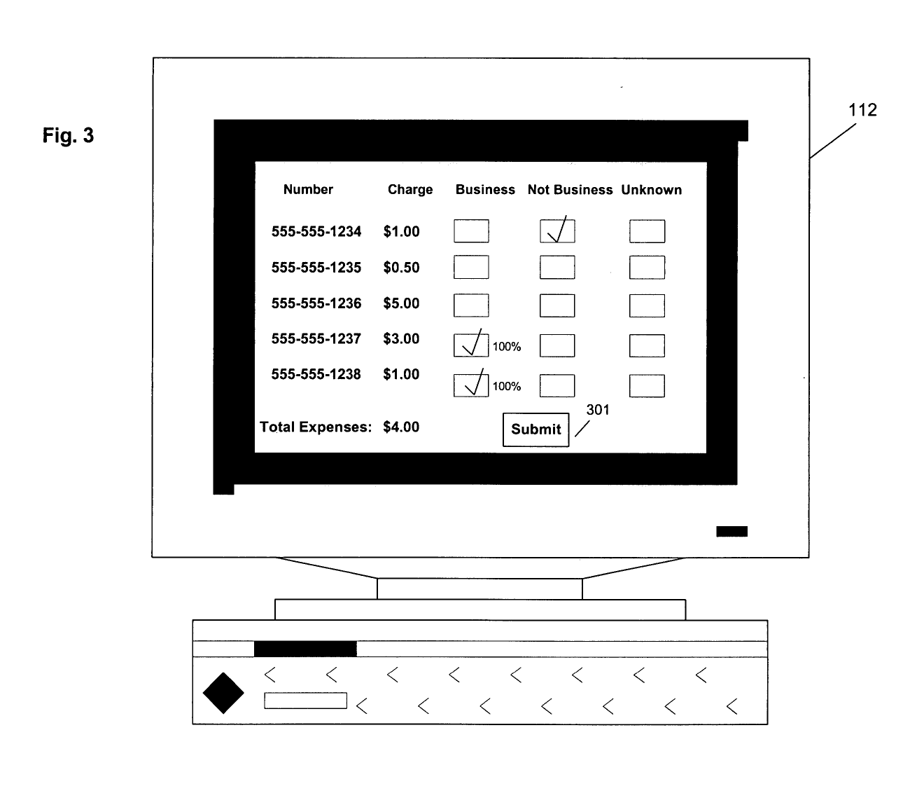

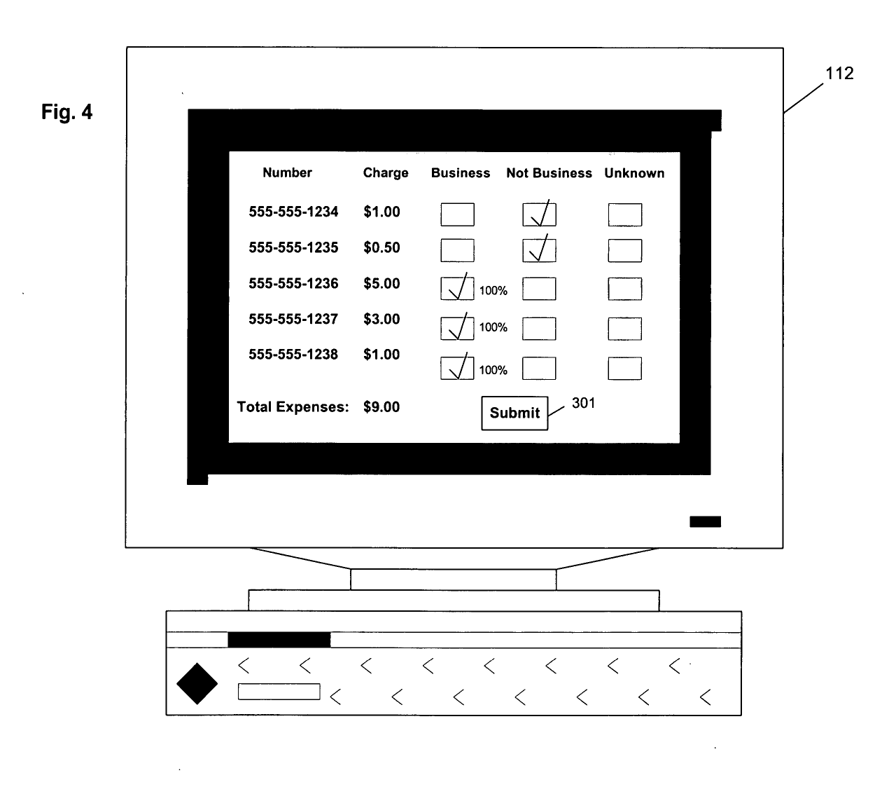

The charges may be made available to the employee for review, for instance, by transmitting an email via interface component 101 to the respective employee 112, 113, or 114 containing a link to a web page. When the employee selects the link, and potentially inputs a valid user name and password, he or she is presented with a web page, as shown at FIG. 3, that displays a form including the employee's list of itemized charges and what category the charges have been assigned. As shown with FIG. 4, the employee then reviews the list and identifies each of the unknown charges as either business-related, in whole or in part; or non-business-related. In the case where the employee is specifying that an itemized charge is partially business-related, the employee may input a percentage indicating the percentage of the charge that should be classified as business-related. The employee may also change the charges categorized by the processing component 102 as business-related, in whole or in part; or non-business-related if he or she believes they are mistakenly categorized or have an improper percentage associated with them in the case of partially business-related charges. Although the user-interfaces shown in FIGS. 3 and 4 are described in the context of a web page for illustration purposes, one skilled in the art will appreciate that any user interface that allows the employee to view and revise their itemized charges will do.

When the employee finishes reviewing the list of charges and categorizing the “unknown” charges, the employee manifests his or her approval and submits his or her changes to the system 100 via interface component 101 by selecting a “submit” button 301 on the web page. If the employee has not identified all of the unknown charges as business or non-business-related, an error message may be transmitted to the employee requiring that he or she do so. Upon receipt of the data from the employee(s) 112, 113, and/or 114, as shown at 204 in FIG. 2, the processing component 102 may make at least the business-related charges approved by the employee(s) 112, 113, and/or 114 available to one or more supervisors 115 for approval. These charges may be made available to the supervisor(s) 115 in the same manner as they were made available to the employees 112-114. The supervisor(s) may also make the same changes that the employees 112-114 are able to, and may select the “submit” button 301 to indicate assent. Although described as receiving input from employees and/or one or more supervisors via a web page, one skilled in the art will appreciate that such input may be received via an other interface capable of transmitting data and that the invention is not so limited.

According to one embodiment of the invention, approval may be performed automatically by the processing component 102 without any supervisor intervention based upon the total expense amount. For example, if all business-related charges total to less than $20, it may be determined that such charges are automatically approved by the processing component 102, thereby obviating the need for a supervisor's approval.

Upon receiving approval 205 in FIG. 2, if required, the processing component 102 updates the data sources 108-110 to incorporate the information provided from the employee(s) 112-114 and/or the supervisor 115. For instance, if an itemized charge was previously unknown, and the employee categorized it as business-related, the previously unknown charge is added to the corresponding data source 108-110 and categorized as business. Therefore, subsequent calculations will identify the previously unknown charge as business-related, in whole or in part, will be more accurate, and will take less time for the employee to review.

At 206 in FIG. 2, the processing component 102 outputs expense information. The expense information may take the form of an expense report showing all itemized charges categorized as business-related, the total expense amount, and the employee and supervisor's approval, which may be their electronic signatures. The expense information may be outputted as a physical paper print-out of the expense report, an electronic file, such as a spreadsheet, or a direct feed of data to an expense system 116 for accounting purposes. The output expense information may also be used to issue a check or some other reimbursement for the associated employee. Although shown in FIG. 1 as being transmitted to an expense system 116, one skilled in the art will appreciate that the expense information may be output to any person or device, and may even be stored within the data storage system 103 and output at a later time.

It is to be understood that the exemplary embodiments are merely illustrative of the present invention and that many variations of the above-described embodiments can be devised by one skilled in the art without departing from the scope of the invention. For instance, although an embodiment of the invention is described in the context of phone bills, one skilled in the art will appreciate that any bill containing itemized charges that may be business-related or non-business-related may be used. Further, although the process steps in FIG. 2 are shown in a particular order, one skilled in the art will appreciate that the invention is not limited to such ordering, which is used merely as an example. It is therefore intended that all such variations be included within the scope of the following claims and their equivalents.

What is claimed is:

1. A computer-implemented method for generating communication expense information, the method comprising:
receiving billing data, the billing data comprising a set of itemized charges;
determining whether items in the set of itemized charges are expenses, in whole or in part, by accessing identifying data useful for identifying at least one of the itemized charges as a known expense, in whole or in part; and
generating expense information based at least upon the billing data and the determination.

2. The method of claim 1 wherein the determining step includes categorizing items in the set of itemized charges as (a) expenses, in whole or in part, (b) not expenses, or (c) unknown.

3. The method of claim 1 further comprising:
receiving approval of at least the itemized charges determined to be expenses in whole or in part.

4. The method of claim 2 further comprising:
transmitting at least the itemized charges categorized as unknown; and
receiving an indication as to whether the unknown itemized charges are (a) expenses, in whole or in part, or (b) not expenses, thereby leaving no itemized charges categorized as unknown.

5. The method of claim 4 further comprising:
updating the identifying data based upon the indication.

6. The method of claim 4 further comprising:
receiving approval of at least the categorized itemized charges.

7. The method of claim 1 wherein the set of itemized charges is a set of charges associated with phone numbers.

8. The method of claim 1 wherein the set of itemized charges is a set of charges associated with phone numbers, and the identifying data comprises a set of phone numbers known to be associated with expenses.

9. The method of claim 1 wherein the expense information is an expense report.

10. The method of claim 4 wherein the set of itemized charges is a set of charges associated with phone numbers, the identifying data comprises a set of phone numbers known to be associated with expenses, and the method further comprises:
adding to the data at least phone numbers associated with charges indicated to be expenses in whole or in part by the received indication.

11. The method of claim 1 wherein the set of itemized charges comprises charges associated with voice calls, text messaging, data file transfers, or image transfers.

12. A system for generating communication expense information, the system comprising:
a data storage system comprising identifying data useful for identifying charges as known expenses;
an interface component; and
a processing component communicatively connected to the data storage system and the interface component, the processing component programmed to perform actions comprising:
receiving billing data via the interface component, the billing data comprising a set of itemized charges;
determining whether items in the set of itemized charges are expenses, in whole or in part, by accessing the identifying data stored in the data storage system; and
generating expense information based at least upon the billing data and the determination.

13. The system of claim 12 wherein the data storage system comprises a computer-readable memory.

14. The system of claim 12 wherein the data storage system comprises a plurality of computer-readable memories.

15. The system of claim 12 wherein the determining step includes categorizing items in the set of itemized charges as (a) expenses, in whole or in part, (b) not expenses, or (c) unknown.

16. The system of claim 12 further comprising:
receiving, via the interface component, approval of at least the itemized charges determined to be expenses in whole or in part.

17. The system of claim 15 further comprising:
transmitting, via the interface component, at least the itemized charges categorized as unknown; and
receiving, via the interface component, an indication as to whether the unknown itemized charges are (a) expenses, in whole or in part, or (b) not expenses, thereby leaving no itemized charges categorized as unknown.

18. The system of claim 17 further comprising:
updating the identifying data stored in the data storage system based upon the indication.

19. The system of claim 12 wherein the set of itemized charges is a set of charges associated with phone numbers.

20. The system of claim 12 wherein the set of itemized charges is a set of charges associated with phone numbers, and the identifying data comprises a set of phone numbers known to be associated with expenses.

21. The system of claim 12 wherein the set of itemized charges comprises charges associated with voice calls, text messaging, data file transfers, or image transfers.

22. The system of claim 12 wherein the expense information is an expense report.

23. The system of claim 17 wherein the set of itemized charges is a set of charges associated with phone numbers, the identifying data comprises a set of phone numbers known to be associated with expenses, and the system further comprises:
adding to the identifying data stored in the data storage system at least phone numbers associated with charges indicated to be expenses, in whole or in part, by the received indication.

24. A computer-implemented method for generating an expense report, the method comprising:
receiving billing data, the billing data comprising a set of itemized charges each associated with a phone number;
categorizing items in the set of itemized charges as (a) expenses, in whole or in part, (b) not expenses, or (c) unknown by accessing identifying data comprising a set of phone numbers known to be associated with expenses;
transmitting at least the itemized charges categorized as unknown;
receiving an indication as to whether the unknown itemized charges are (a) expenses, in whole or in part, or (b) not expenses, thereby leaving no itemized charges categorized as unknown;
adding to the identifying data at least phone numbers associated with charges indicated to be expenses in whole or in part by the received indication;
receiving approval of at least the itemized charges categorized as expenses, in whole or in part; and
generating an expense report based at least upon the billing data and the approved itemized charges.

25. A system for generating an expense report, the system comprising:
a data storage system storing identifying data comprising a set of phone numbers known to be associated with expenses, in whole or in part;
an interface component; and
a processing component communicatively connected to the data storage system and the interface component, the processing component programmed to perform actions comprising:
receiving billing data via the interface component, the billing data comprising a set of itemized charges each associated with a phone number;
categorizing items in the set of itemized charges as (a) expenses, in whole or in part, (b) not expenses, or (c) unknown by accessing the identifying data stored in the data storage system;
transmitting, via the interface component, at least the itemized charges categorized as unknown;
receiving, via the interface component, an indication as to whether the unknown itemized charges are (a) expenses, in whole or in part, or (b) not expenses, thereby leaving no itemized charges categorized as unknown;
adding to the identifying data stored in the data storage system at least phone numbers associated with charges indicated to be expenses in whole or in part by the received indication;
receiving approval of at least the itemized charges categorized as expenses, in whole or in part, via the interface component; and
generating an expense report based at least upon the billing data and the approved itemized charges.
